(19) United States
(12) Patent Application Publication
(10) Pub. No.: US 2011/0214921 A1
(43) Pub. Date: Sep. 8, 2011

(54) Polycrystalline Diamond Abrasive Compact

(76) Inventor: Kaveshini Naidoo, Springs (ZA)

(21) Appl. No.: 13/060,063

(22) PCT Filed: Aug. 21, 2009
(86) PCT No.: PCT/IB2009/053688

§ 371 Date: May 12, 2011

(30) Foreign Application Priority Data
Aug. 21, 2008 (GB) 0815229.0

(51) Int. Cl. E21B 10/36; B24D 3/04; B01J 3/06

(52) U.S. Cl. 175/428; 51/307; 428/408; 428/338; 428/312.2

(57) ABSTRACT

A polycrystalline diamond (PCD) material and method for making the PCD material are provided. The PCD so produced comprises a skeletal diamond structure formed of intergrown diamond grains and defines interstitial regions between the diamond grains. The skeletal diamond structure contains metal carbide structures or particles that are occluded from the interstitial regions by diamond.

### BACKGROUND OF THE INVENTION

This invention relates to polycrystalline diamond (PCD) materials, methods for making the same, elements comprising the same and tools comprising the same.

Polycrystalline diamond compacts are used extensively in cutting, milling, grinding, drilling and other abrasive operations. A commonly used compact is one that comprises a layer of polycrystalline diamond (PCD) bonded to a cemented carbide substrate. The layer of PCD presents a working face and a cutting edge around a portion of the periphery of the working surface.

Polycrystalline diamond materials are well known in the art. Conventionally, PCD is formed by combining diamond grains with a suitable solvent/catalyst and subjecting the green body to high pressures and temperatures to enable the solvent/catalyst to promote inter-crystalline diamond-to-diamond bonding between the grains. The sintered PCD has sufficient wear resistance and hardness for use in aggressive wear, cutting and drilling applications.

The solvent/catalyst for use in PCD is normally among the Group VIII materials, with Co being the most common. Conventionally, PCD contains 80 to 95 volume % diamond with the remainder being the solvent/catalyst material.

When diamond particles are combined with a suitable metallic solvent/catalyst, this solvent/catalyst promotes diamond-to-diamond bonding between the diamond grains, resulting in an intergrown or sintered structure. This intergrown diamond structure therefore comprises original or feedstock diamond grains as well as newly precipitated diamond phase which bridges or forms necks between these original grains. In the final sintered structure, solvent/catalyst material remains present within the interstices that exist between the sintered diamond grains.

A well-known problem experienced with this type of PCD compact, however, is that the residual presence of solvent/catalyst material in the microstructural interstices has a detrimental effect on the performance of the compact at high temperatures. This decrease in performance under thermally demanding conditions is postulated to arise from two different behaviours of the metallic-diamond compact.

The first arises from differences between the thermal expansion characteristics of the interstitial solvent/catalyst and the sintered diamond network. At temperatures much greater than 400° C., the metallic component expands far more than the intergrown diamond network and can generate micro-fracturing of the diamond skeleton. This micro-fracturing significantly reduces the strength of the bonded diamond at increased temperatures.

Additionally, the solvent/catalyst metallic materials which facilitate diamond-to-diamond bonding under high-pressure, high-temperature sintering conditions can equally catalyse the reversion of diamond to graphite at increased temperatures and reduced pressure with obvious performance consequences. This particular effect is mostly observed at temperatures in excess of approximately 700° C.

As a result, PCD sintered in the presence of a metallic solvent/catalyst, notwithstanding its superior abrasion and strength characteristics, must be kept at temperatures below 700° C. This significantly limits the potential industrial applications for this material and the potential fabrication routes that can be used.

Potential solutions to this problem are well-known in the art. One type of approach focuses on the use of alternative or altered sintering aid materials. These materials, when present in the final sintered structure, exhibit much reduced retro-catalytic efficacy at high temperatures and typically have thermal expansion behaviours better matched to those of the sintered diamond phase. However, these types of compact typically suffer several problems. Firstly, whilst in some cases it is possible to achieve some reasonable degree of diamond-to-diamond bonding, the nature of this bonding is typically weaker than that which can be achieved with the more conventional metallic solvent/catalyst sintering aids. Hence the strength and abrasion resistance of these materials is compromised compared to conventional metallic-based PCD materials.

Another approach attempts to retain the benefits of a metallic catalyst/solvent sintered PCD, whilst hindering the thermal degradation mechanisms experienced by these compacts after sintering. It typically focuses on post-sintering reduction or removal of the catalytic phase through chemical leaching, or transforming or rendering the catalytic phase inert through a chemical reaction. One of the solutions to the above problem is to remove the solvent/catalyst from the surface of the sintered PCD. This involves initially sintering the PCD and then subjecting the PCD to an acid treatment to remove the solvent/catalyst. This is, however, a multistage process and it would be beneficial to have a more thermally stable PCD in one step.

PCT patent application publication number WO2007/017745 discloses a PCD material formed in the presence of low levels of rare earth metal borides as well as the metal borides zirconium boride, chromium boride, calcium boride and magnesium boride. These compounds react in situ as “getters” of residual oxygen in the sintering environment by forming metal oxides. They also introduce boron into the sintering environment, whose benefits are well-known in the art. Using these metal borides, the abrasion resistance of the resultant material is improved.

United Kingdom patent number GB1376467 discloses the manufacture of an electrically conductive diamond compact that comprises boron-doped diamond or beryllium-doped cBN powder mixed with a binder of zirconium diboride or titanium diboride (or mixtures thereof) and sintered at HpHT conditions. No thermal stability issues relating to graphitisation are anticipated, as there is no conventional diamond catalyst/solvent present in this compact and hence no diamond-to-diamond intergrowth is expected.

United Kingdom patent number GB1496106 discloses a boron-doped PCD material produced by using a conventional diamond catalyst/solvent and elemental boron, which is added at levels less than 1 mass %, more preferably between 0.3 and 0.7 mass %. The boron may alternatively be introduced as boron-doped diamond powder. Suitable solvent/catalyst metal systems discussed are cobalt, iron, nickel, manganese, tantalum and alloys thereof, albeit that tantalum is not conventionally regarded as a diamond solvent/catalyst metal in the art.

U.S. Pat. No. 4,907,377 discloses a PCD containing a mixture of boron and a solvent catalyst such as tantalum. it is known that tantalum has a high affinity for carbon and prefers to form carbides rather than act as a catalyst for diamond intergrowth. It is claimed that using a directional catalyst alloy sweep through method, improved diamond intergrowth is achieved. It is further claimed that the additives mentioned in the patent impart certain advantages to the PCD such as improved consistency and reproducibility of the PCD, and improved carbide life due to the boron lowering the sintering temperature of the compact.

United Kingdom patent number GB2408735 claims a PCD comprising a first phase of bonded together diamond crystals and a second phase of a reaction product between a solvent/catalyst material used to facilitate diamond bonding and a material that reacts with the solvent/catalyst. This reaction product is said to have a CTE (coefficient of thermal expansion) that is closer to the bonded diamond than to the solvent/catalyst material and hence provides a more thermally stable PCD. Refractory metals such as tantalum, titanium and zirconium are added as a barrier layer between the PCD and the WC-Co support to minimize the cobalt infiltration into the PCD, thereby improving thermal stability.

United Kingdom patent number GB240526 describes a PCD compact comprising boron-doped diamond sintered together with a secondary material containing Ta, Mo or Ti carbides or borides or mixtures thereof.

European Patent Convention patent number 1 775 275 discloses a high strength, high wear resistance fine-grained PCD (less than 2 μm diamond grain size) that is achieved by limiting the occurrence of abnormal diamond grain growth during sintering. (This is a problem that typically occurs in finer-grained diamond structures where the increased solubility of fine diamond grains can lead to rapid supersaturation of the molten binder and hence uncontrolled diamond growth.) Grain growth control is typically achieved using metal particles that “getter” the excess carbon by forming a carbide from within the binder phase, before allowing it to precipitate as diamond. The method of the patent therefore involves the incorporation of fine metal or metal carbide particles into the binder metallurgy which then manifest as sub-0.8 μm metal carbide particles occurring within the binder phase of the final PCD product. The preferred metal is titanium, although the use of zirconium, hafnium, vanadium, niobium, tantalum, chromium and molybdenum is also described.

U.S. Pat. No. 4,231,762 discloses a sintered compact tool material which has a uniform structure. It consists of diamond particles finer than one micron bonded by a carbide finer than one micron, which is mainly composed of WC. The sintered compact comprises 60 volume percent of diamond and the balance WC finer than one micron. Clearances between diamond particles finer than one micron are filled with finer WC particles, and by sintering the mix under super-pressures, it is possible to obtain a completely dense compact without the necessity of a liquid phase. Since there exists little liquid phase, which is essential for the crystal growth of diamond, and since WC particles fill the clearances between diamond particles, the crystal growth is completely depressed during sintering of the diamond.

PCT patent application publication number WO2008/062369 discloses an in situ method of making a diamond-containing material (DCM) comprising diamond particles and a second phase containing an intermetallic compound. It comprises providing a reaction mass of reactants capable, on reaction, of producing carbon and an intermetallic compound and subjecting the reaction mass to diamond synthesis conditions. Reactions suitable for this invention include: silicide/boride/nitride carbon precipitation reactions—these involve the formation of an intermetallic silicide or similar boride or nitride structure. Group IVa and Va (e.g. titanium, vanadium, niobium and tantalum) silicides, borides or nitrides may be produced.

### SUMMARY OF THE INVENTION

According to a first aspect of the invention, there is provided a polycrystalline diamond (PCD) material comprising a skeletal diamond structure formed of intergrown diamond grains and defining interstitial regions between the diamond grains, wherein the skeletal diamond structure contains metal carbide structures or particles that are occluded from the interstitial regions by diamond.

In some embodiments the PCD material has an oxidation onset temperature of at least 800 degrees centigrade, at least 900 degrees centigrade or even at least 950 degree centigrade.

Preferably the metal carbide structures or particles comprise a carbide compound of a refractory metal that has a solubility in cobalt of about 15 atomic percent or less at about 1,100 degrees centigrade. More preferably the metal carbide structures or particles comprise a carbide compound of a refractory metal that has a solubility in cobalt in the range of about 0.5 atomic percent to about 15 atomic percent at about 1,100 degrees centigrade. In general, the lower the solubility of the refractory metal in cobalt at about 1,100 degrees centigrade, the greater the content of occluded metal carbide structures or particles within the skeletal diamond structure. The greater the content of the occluded metal carbide structures or particles within the skeletal diamond structure, the greater is believed to be the benefits of enhanced thermal stability of the PCD material.

Preferably the metal carbide structures or particles comprise tantalum carbide (TaC), niobium carbide, titanium carbide (TiC), zirconium carbide, tungsten carbide or molybdenum carbide, and more preferably the metal carbide structures or particles comprise tantalum carbide, niobium carbide or titanium carbide, and yet more preferably the metal carbide structures or particles comprise tantalum carbide.

In an embodiment, at least some of the intergrown diamond grains comprise an inner volume and an outer volume, the outer volume being integrally formed over at least part of the inner volume, the inner volume comprising plastically deformed diamond, the diamond of the outer volume being substantially less plastically deformed than that of the inner volume, and the occluded metal carbide structures or particles occuring within the outer volumes of the intergrown diamond grains. In an embodiment the outer volumes of the intergrown diamond are substantially free of plastic deformation. In a further embodiment the inner volumes of the intergrown diamond grains are substantially devoid of the metal carbide structures or particles.

In some embodiments the respective outer volumes comprise from about 1 percent or more, or from about 5 percent or more, of the total volume of the skeletal diamond structure. In some embodiments the respective outer volumes comprise from about 50 percent or less, from about 20 percent or less, or from about 10 percent or less, of the total volume of the skeletal diamond structure.

In some embodiments the mean size of the metal carbide structures or particles may be from about 0.05 microns or more, or from about 0.1 microns or more. In some embodiments the mean size of the metal carbide structures or particles may be from about 5 microns or less, from about 2 microns or less, or even from about 1 micron or less.

In an embodiment the interstitial region or regions within at least a portion of the PCD material may contain a filler material, which may comprise a solvent/catalyst for diamond, such as cobalt. In some embodiments, there may be less than 5 volume percent, less than 2 volume percent, less than 1 volume percent or less than 0.5 volume percent of solvent/catalyst for diamond within the PCD material.

In embodiments of the invention at least a portion of the PCD material may be porous. In some embodiments substantially the entire PCD material may be porous. It has been found that PCD material having low content of solvent/catalyst material for diamond or which is substantially free of solvent/catalyst for diamond has enhanced thermal stability.

In embodiments where the PCD material includes solvent/catalyst material, compounds including the metal, the solvent/catalyst material and an additional element may be present within the interstitial regions. In an embodiment, a compound containing cobalt, a metal such as tantalum or titanium, and boron may be present within the interstitial region or regions. The presence of such a compound has been found to enhance the thermal stability of the PCD material. In embodiments where the metal carbide includes tantalum and where boron is present, the intermetallic boride compound BₓC_{y}Ta_{z} may be present within the interstitial regions, where ₓ may be 6, y may be 22.13 and z may be 0.87.

In embodiments of the invention the PCD material comprises at least 90 volume percent diamond, the inter-grown diamond grains having a mean size in the range from 0.1 micrometres to 25 micrometres, in the range from 0.1 micrometres to 20 micrometres, in the range from 0.1 micrometres to 15 micrometres, in the range from 0.1 micrometres to 10 micrometres, or in the range from 0.1 micrometres to 7 micrometres. Generally the PCD has diamond content in the range from 90 to 99 volume percent. In one embodiment the PCD comprises at least 92 volume percent diamond. The invention has been found to be especially advantageous when applied to PCD having fine diamond grains, and generally the finer the grain size, the greater the benefits of the invention.

According to a further embodiment of the invention there is provided a PCD composite structure comprising a first portion having a first skeletal diamond structure formed of intergrown diamond grains and defining interstitial regions between the diamond grains and a second portion having a second skeletal diamond structure formed of intergrown diamond grains and defining interstitial regions between the diamond grains, the first skeletal structure containing metal carbide structures or particles that are occluded from the interstitial regions of the first portion by diamond, and the second skeletal structure being substantially devoid of metal carbide structures or particles that are occluded from the interstitial regions of the second portion by diamond. Preferably the first portion is adjacent a working surface and the second portion is remote from the working surface. The working surface of such embodiments may have enhanced abrasion resistance and enhanced thermal stability, which may be advantageous in applications where the working surface engages rock or other hard materials in use.

In embodiments of the invention the PCD material comprises diamond grains having a multi-modal size distribution. In some embodiments the inter-grown diamond grains have the size distribution characteristic that at least 50 percent of the grains have a mean size greater than 5 microns, and at least 20 percent of the grains have a mean size in the range from 10 to 15 microns.

According to a further embodiment of the invention there is provided a PCD composite compact element comprising a PCD structure secured to a support substrate formed of cemented carbide, such as cobalt-cemented tungsten carbide, wherein the PCD structure is formed of PCD material according to an embodiment of the invention.

According to a further aspect of the invention there is provided a method of manufacturing a PCD compact, the method including introducing a metal carbide former, in the form of a metal compound comprising a metal that is capable of reacting with carbon to form a metal carbide, and boron and/or nitrogen, into an aggregated plurality of diamond grains to form a pre-sinter mass, and sintering the pre-sinter mass in the presence of a solvent/catalyst material for diamond at a pressure and a temperature at which diamond is thermodynamically stable in order to form PCD. For example, the pressure may be at least 5.5 gigapascals and the temperature may be at least 1,400 degrees centigrade. The metal compound is not a metal carbide.

Preferably the metal compound comprises a boride, nitride, carbo-nitride, boro-nitride, metal boro-carbide or metal boro-carbo-nitride of a refractory metal that has a solubility in cobalt of about 15 atomic percent or less at about 1,100 degrees centigrade. More preferably the metal compound comprises a boride, nitride, carbo-nitride or boro-nitride of a refractory metal that has solubility in cobalt in the range from about 0.5 atomic percent to about 15 atomic percent at about 1,100 degrees centigrade.

In some embodiments the metal compound is a nitride, boride, carbo-nitride or boro-nitride of tantalum, niobium, titanium, zirconium, tungsten or molybdenum.

In some embodiments the metal compound is tantalum boride, TaB or TaB₂, tantalum nitride, tantalum carbo-nitride, tantalum boro-nitride, niobium boride or zirconium diboride.

Preferably the metal compound is a nitride or boride of tantalum, niobium or titanium, more preferably the metal compound is tantalum boride, tantalum diboride, or titanium diboride, and yet more preferably the metal compound is tantalum diboride.

In one embodiment of the method, the metal compound is introduced in the form of grains or particles, such as in powder form. In another embodiment, the metal compound is introduced in the form of a coating or other adherent structure on the diamond grains.

Embodiments of the method have been found to result in PCD material wherein the skeletal structure contains metal carbide structures or particles that are occluded from the interstitial regions by diamond.

A mixture of tantalum borides or other tantalum carbide formers may also be used. Where the tantalum carbide former is solely a boride, it is typically added at a level of between 0.1 and 20 weight %, preferably 1 to 6 weight %, and more preferably 4 to 6 weight % of the mass of diamond particles.

In a preferred embodiment where the metal compound is tantalum boride, namely TaB or TaB₂, or a mixture thereof, the intermetallic boride compound BₓC_{y}Ta_{z} may be present within the interstitial regions of the sintered PCD, where ₓ may be 6, y may be 22.13 and z may be 0.87.

In another form of the invention, the occluded carbide structures may not be pure TaC or Ta₂C, but may include mixed carbides formed by including other elements such as Cr, V and the like.

The invention extends to the use of the PCD composite compact elements of the invention as abrasive cutting elements, for example for cutting or abrading of a substrate or in drilling applications.

According to another embodiment of the invention there is provided a tool comprising a PCD composite compact element according to an embodiment of the invention, the tool being for cutting, milling, grinding, drilling, earth boring, rock drilling or other abrasive applications, such as the cutting and machining of metal.

The PCD composite compact element may comprise a cutting element for a drilling tool in the form of an earth boring bit, preferably a rotary shear-cutting bit for use in the oil and gas drilling industry.

The PCD composite compact element may comprise a cutting element for a rolling cone, hole opening tool, expandable tool, reamer or other earth boring tools.

### BRIEF DESCRIPTION OF THE DRAWINGS

The invention will now be described in more detail, by way of example only, with reference to the accompanying figures, in which:

FIG. 1 is a diagrammatic representation of a portion of a PCD abrasive material of an embodiment of the invention;

FIG. 2 is a SEM micrograph of a PCD abrasive material of an example embodiment of the invention;

FIG. 3 is an X-ray diffraction spectrum of the sintered PCD abrasive material of FIG. 2;

FIG. 4 is a graph representing the oxidation resistance of the PCD abrasive material of FIG. 2 as compared to that of a standard PCD abrasive material;

FIG. 5 is a graph representing the thermal stability of the PCD abrasive material of FIG. 2 as compared to that of a standard PCD material;

FIG. 6 is a low magnification TEM image of a PCD abrasive material of another example embodiment of the invention, and

FIG. 7 is a higher magnification TEM image of the PCD abrasive material of FIG. 6.

### DETAILED DESCRIPTION OF EMBODIMENTS

A solvent/catalyst for diamond is understood to be a material that is capable of promoting the growth of diamond or the direct diamond-to-diamond inter-growth between diamond grains at a pressure and a temperature condition at which diamond is thermodynamically stable.

“Occluded” is understood to mean that the structures or particles are wholly enclosed by or embedded within diamond.

This invention relates to the improvement in PCD materials by the incorporation of a metal carbide former, preferably in the form of a metal compound comprising a metal that is capable of reacting with carbon to form a metal carbide and boron and/or nitrogen, into the sintering environment of the PCD. PCD so produced comprises a skeletal diamond structure formed of intergrown diamond grains and defines interstitial regions between the diamond grains. The skeletal diamond structure contains metal carbide structures or particles that are occluded from the interstitial regions by diamond. It has been found that such PCD materials exhibit enhanced thermal stability and enhanced abrasion resistance.

For convenience, in what follows, reference will be made to a metal boride or metal borides (metal boride(s)), it being understood that other metal carbide formers may also be used, provided that they are capable of forming the occluded metal carbide structures or particles that are peculiar to the PCD material of the invention.

Polycrystalline diamond is produced by subjecting a mixture of diamond particles and a transition metal solvent/catalyst or mixture of transition metal solvent/catalysts to high pressures and temperatures to promote diamond-diamond bonding in order to form a continuous network or skeleton of intergrown diamond particles.

The diamond particles are typically provided as a mass in the range of 60 to 95% by volume, preferably in the range of 80 to 95% by volume, the remainder of the diamond powder mixture comprising the metal boride(s), and the solvent/catalyst.

The pre-sinter diamond mixture containing the diamond particles, the metal boride(s), and solvent/catalyst is sintered at high pressures and temperatures with or without a tungsten carbide backing.

For example, the pressure may be at least 5.5 gigapascals and the temperature may be at least 1,400 degrees centigrade. In some embodiments the pressure is greater than 6.0 gigapascals, at least 6.2 gigapascals, at least 6.5 gigapascals, at least 7 gigapascals or even at least 8 gigapascals. In general, it has been found that the higher the pressure, the greater the enhancement of the thermal stability and abrasion resistance of the sintered PCD.

The diamond particles or grains typically have an average particle size in the range 0.1 to 50 μm, and preferably within the range of 0.1 to 20 μm.

The metal boride(s) may be incorporated into the PCD using a variety of methods. In some cases, the metal boride(s) may be introduced in a pre-synthesis step into the diamond powder mixture prior to the high pressure sintering step, whilst in others it may be introduced from a separate source during the high pressure sintering step.

Pre-synthesis methods of introduction for particulate forms of the metal boride(s) include mechanical mixing and milling techniques well known in the art such as ball milling (wet and dry), shaker milling and attritor milling. Other pre-synthesis techniques such as precursor methods of generating the metal boride(s) (or suitable mixtures of metal borides) may also be used. These include the methods disclosed in PCT patent application publication number WO/2006/032984. Using the sol-gel technique disclosed in that application, an intimate distribution of the metal boride additive and diamond powder can be formed. Other known methods of coating the diamond grains with a metal carbide former may also be used.

A high pressure cycle route that can be used for the introduction of the tantalum boride material is through the placement of a tape, shim or foil containing the tantalum boride material at the interface between the carbide substrate and the diamond powder and then co-infiltrating the tantalum boride into the diamond layer with the solvent/catalyst infiltrant. A tape, shim or foil method can also be used in the manufacture of PCD compacts that contain no carbide substrate.

It is believed that the physico-chemical speciation of the tantalum boride assists in achieving the final desirable occluded TaC structure. For example, if elemental Ta particles are employed, the reaction between the Ta and the diamond carbon source to form TaC occurs very early in the sintering cycle or even during presynthesis outgassing, and the resultant TaC structures are typically large and are not typically occluded within the new diamond network. They rather occur predominantly, as with other conventional PCD contaminants or additives, within the binder pools or interstitial regions in the PCD microstructure.

The tantalum boride is added in the range of 0.1 to 20 weight % of the diamond mass (preferably 1 to 6 weight %, and more preferably 4 to 6% weight). The tantalum borides that are added to the diamond may be stoichiometric or sub-stoichiometric. The boron concentration is added in the range of 0.01 to 2 weight % (preferably 0.05 to 0.4 weight %, and more preferably 0.15 to 0.3 weight %) of the diamond mass.

The tantalum borides need not be added to the diamond particles as individual metal borides, but may be added as a combination of borides along with other metals, for example a combination of TaB₂ and VB₂. Furthermore, in the sintered material, the tantalum carbide need not precipitate out as individual carbides. They may precipitate out as mixed carbides for example a VC—WC—TiC particle. The precipitated carbides may be stoichiometric or substoichiometric.

Where the tantalum boride additive is introduced in particulate form, it is desirable that the particle size of the additive is comparable to that of the diamond grains, and more preferable if the additive particles are finer in size than the diamond grains. It is also preferable that the oxygen content of the tantalum boride additive be as low as possible, at least less than 1000 ppm, preferably less than 100 ppm and most preferably less than 10 ppm.

The method of the invention results in the formation of unique TaC-based deposition structures within the PCD. These unique structures are formed by the in situ formation and deposition of metal carbide phases within regions of re-grown diamond or newly precipitated diamond i.e. these structures are typically entirely occluded by diamond rather than occurring in the metallic binder or interstitial regions of the PCD (i.e. surrounded by cobalt metal and other binder phases) as is common with other sintering impurities such as tungsten carbide. With this invention, it is still common to see some Ta-based carbide inclusions forming within the metallic binder regions of the PCD, although it is the occluded Ta-based carbides that are desirable and characteristic of the invention.

This unique microstructural character is most easily observable using well-established electron microscope techniques known in the art such as TEM (transmission electron microscopy), SEM (scanning electron microscopy), HRTEM or HRSEM (high resolution TEM and SEM, respectively). The detailed elemental character of the occluded materials of this invention may be probed using methods known in the art such as X-ray fluorescent spectroscopy (XRF) and electron diffraction spectroscopy (EDS).

The most effective manner of observing the nature of the occluded Ta-based carbide particles is by using TEM methods. Here the occluded nature of the TaC deposits within the diamond skeleton is easily visible. It is also possible to identify the nature of the occluding diamond phase using Kikuchi lines generated using electron back-scattered diffraction (EBSD) under TEM. These features, well known to those skilled in the art, originate due to the coherent Bragg diffraction of inelastically scattered electrons and are characteristically strong in highly crystalline materials. New diamond precipitating in situ during the HpHT sintering cycle is highly crystalline, especially when compared with “old” or feedstock diamond grains that have been plastically deformed and crushed by the sintering cycle. Kikuchi lines are extremely weak or not observable for feedstock diamond, but are strongly observed in freshly precipitated or “new” diamond.

Observations of the surrounding diamond phase of the Ta-based carbide precipitates shows that, as this is largely dominated by newly grown diamond, these precipitates were incorporated into the diamond skeleton during the HpHT sintering process, rather than mechanically trapped between feedstock diamond grains during HpHT compaction. Furthermore, the precipitate phases are likely to have formed in situ themselves (rather than form/exist as particulates prior to sintering) because of their fine scale and even distribution within the new diamond phase. This co-formation and structural integration step may assist in achieving the benefits of the invention.

It has been found that significant improvements in PCD material performance are observed when comparing materials of the invention with prior art materials.

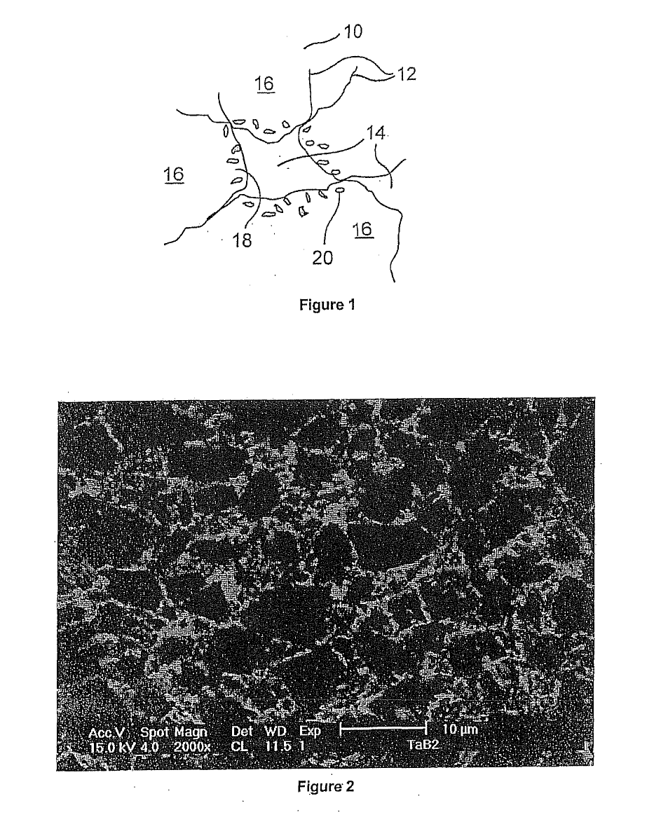

Turning to accompanying FIG. 1, there is shown diagrammatically a portion of a PCD abrasive compact 10 comprising an intergrown diamond skeleton 12 having interstitial regions or binder pools 14 dispersed therein. The diamond skeleton 12 consists of polycrystalline diamond grains 16 having re-grown diamond regions 18 (“new” diamond) that precipitated during the sintering process. Located within the re-grown diamond regions 18 are occluded TaC structures 20, which TaC structures are occluded from the interstitial regions 14. Without wishing to be bound by theory it is postulated that the occluded TaC structures 20 protect the intergrown diamond skeleton 12 from thermal degradation by forming a tantalum carbide barrier within the re-grown diamond regions 18.

There may also be further advantages in the use of boride-based additives. The boron disassociates from the secondary material (i.e. Ta) and lowers the sintering temperature of the PCD compact, facilitating more effective sintering and a potentially improved diamond intergrowth result for a given p,T condition. Furthermore, boron can be incorporated in the re-grown diamond as either particulates or agglomerates. This incorporated boron may impart a degree of protection to the PCD against oxidation and corrosion.

Property and mechanical behaviour advantages such as improved oxidation resistance, improved corrosion resistance, improved wear resistance and improved thermal stability, for example, are observable using techniques such as Thermogravimetric Analysis (TGA) used to measure the rate of oxidation, Paarl Granite Turning Test (PGT) used as a measure of the wear resistance, X-ray Diffraction (XRD) used as a measure to detect the various phases of compounds formed, and an abrasion test to measure wear rate.

Embodiments may exhibit no substantial structural degradation or deterioration of hardness and abrasion resistance after exposure to a temperature above about 400 degrees centigrade, in the range from about 750 degrees centigrade to about 800 degrees centigrade, and by way of non-limiting example in the range from about 760 degrees centigrade to about 810 degrees centigrade. Embodiments of PCD material having enhanced thermal stability have been found to better retain structural integrity and key mechanical properties after being bonded to the substrate, such as by brazing.

The size distribution of unbonded or free-flowing diamond grains may be measured by means of a laser diffraction method, wherein the grains are suspended in a fluid medium and an optical diffraction pattern is obtained by directing a laser beam at the suspension. The diffraction pattern is interpreted by computer software and the size distribution is expressed in terms of equivalent circle diameter. In effect, the grains are treated as being spherical and the size distribution is expressed in terms of a distribution of equivalent diameters of spheres. A Mastersizer™ apparatus from Malvern Instruments Ltd, United Kingdom, may be used for this purpose.

In order to obtain a measure of the sizes of diamond grains or other structures or particles within PCD, a method known as “equivalent circle diameter” may be used. In this method, a scanning electron micrograph (SEM) image of a polished surface of the PCD material is used. The magnification and contrast should be sufficient for at least several hundred diamond grains to be identified within the image. The diamond grains or other structures can be distinguished from metallic phases in the image. A circle equivalent in size for each individual diamond grain can be determined by means of conventional image analysis software. The collected distribution of these circles is then evaluated statistically. Wherever diamond mean grain size or the mean size of a structure or particle within PCD material is referred to herein, it is understood that this refers to the mean equivalent circle diameter.

A multi-modal size distribution of a mass of grains is understood to mean that the grains have a size distribution that is formed of more than one peak, each peak corresponding to a respective “mode”. Multimodal polycrystalline bodies are typically made by providing more than one source of a plurality of grains, each source comprising grains having a substantially different mean size, and blending together the grains from the sources. Measurement of the size distribution of the blended grains typically reveals distinct peaks corresponding to distinct modes. When the grains are sintered together to form the polycrystalline body, their size distribution is further altered as the grains are compacted against one another and fractured, resulting in the overall decrease in the sizes of the grains. Nevertheless, the multimodality of the grains is usually still clearly evident from image analysis of the sintered article.

As noted previously, embodiments of the PCD material may have an oxidation onset temperature of at least 800 degrees centigrade, more preferably at least 900 degrees centigrade and even more preferably at least 950 degree centigrade. Embodiments of such PCD have been found to have superior thermal stability and exhibit superior performance in applications such as oil and gas drilling, wherein the temperature of a PCD cutter element can reach several hundred degrees centigrade. Oxidation onset temperature is measured by means of thermo-gravimetric analysis (TGA) in the presence of oxygen, as is known in the art.

The invention will now be described in more detail, by way of example only, with reference to the following non-limiting examples.

### Example 1

A mixture of 5 weight % particulate TaB₂ and the balance monomodal diamond was ball-milled for 1 hour in order to form a uniform mixture. Scanning electron microscopy (SEM) showed the resultant mixture to be homogeneous. The powder mixture was placed onto a cemented tungsten carbide substrate incorporating solvent/catalyst cobalt, and treated in a vacuum furnace to remove any impurities. The resultant pre-composite was then subjected to HpHT conditions in order to achieve a sintered PCD compact.

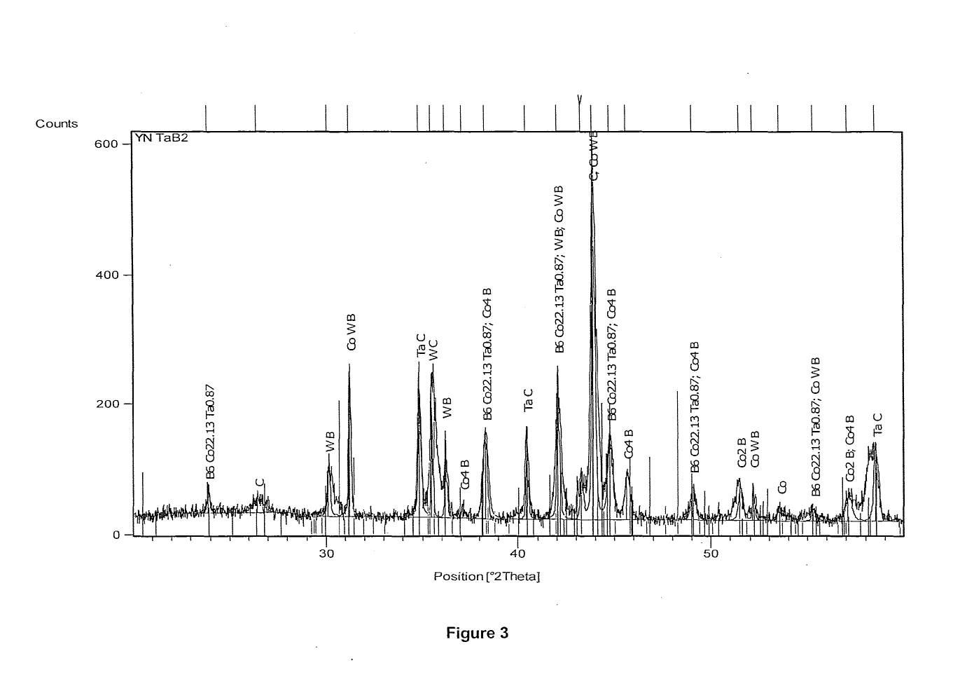

SEM analysis of the resultant product showed the presence of a substantial amount of diamond intergrowth in the compact, as shown in accompanying FIG. 2. The dark regions in the micrograph represent the diamond phase, the grey regions represent the solvent/catalyst cobalt and the lighter regions represent the metal carbide phases. Electron diffraction spectroscopy and X-ray diffraction (refer to accompanying FIG. 3) were used to confirm the presence of metal carbides and metal borides within the sintered compact.

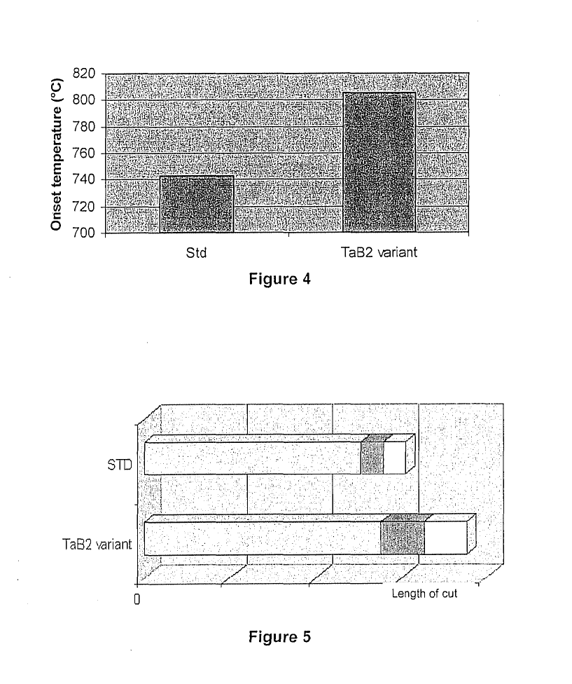

As shown in accompanying FIG. 4, the addition of TaB₂ to PCD also showed enhanced oxidation resistance when measured using a Thermogravimetric Analyser. When the PCD compact containing the occluded metal carbides is compared to a standard PCD compact, a vast difference is observed between these two compacts. It is clear from FIG. 4 that the compact containing TaC is superior in terms of its resistance towards oxidation. This is especially useful in environments where oxidative and corrosive conditions are prevalent, for example during drilling applications.

There was also an observed improvement in the abrasion resistance of the sintered compact of the invention when compared to a standard PCD compact.

Referring to accompanying FIG. 5, which shows graphically the results of a thermal stability test for the compact of the example, it is clear that the addition of TaB₂ to PCD results in a significant improvement in thermal stability over a standard PCD compact.

The combination of the above analysis results shows that the addition of tantalum boride, in the examples TaB₂, to the PCD compact does not compromise the diamond intergrowth in the compact, nor does it result in any significant deterioration of the wear resistance of the PCD compact. Conversely, the oxidation resistance of the compact is vastly improved and the compact is shown to possess an enhanced thermal stability.

### Example 2

A mixture of 1 weight % TaB₂ and the remainder a bimodal mixture of diamond particles was ball-milled for 1 hour in order to obtain a uniform mixture. Scanning electron microscopy (SEM) showed the resultant mixture to be homogeneous. The resultant powder mixture was then placed onto a cemented tungsten carbide substrate incorporating solvent/catalyst cobalt, and treated in a vacuum furnace to remove any impurities. This pre-composite was then subjected to HpHT conditions in order to obtain a sintered compact.

SEM analysis showed the presence of a substantial amount of diamond intergrowth in the compact. Electron diffraction spectroscopy and X-ray diffraction were used to confirm the presence of metal carbides and metal borides in the sintered compact. In terms of the analysis test results, the results obtained were similar to those obtained for Example 1 in that there was a definite improvement in the thermal stability of the PCD compact.

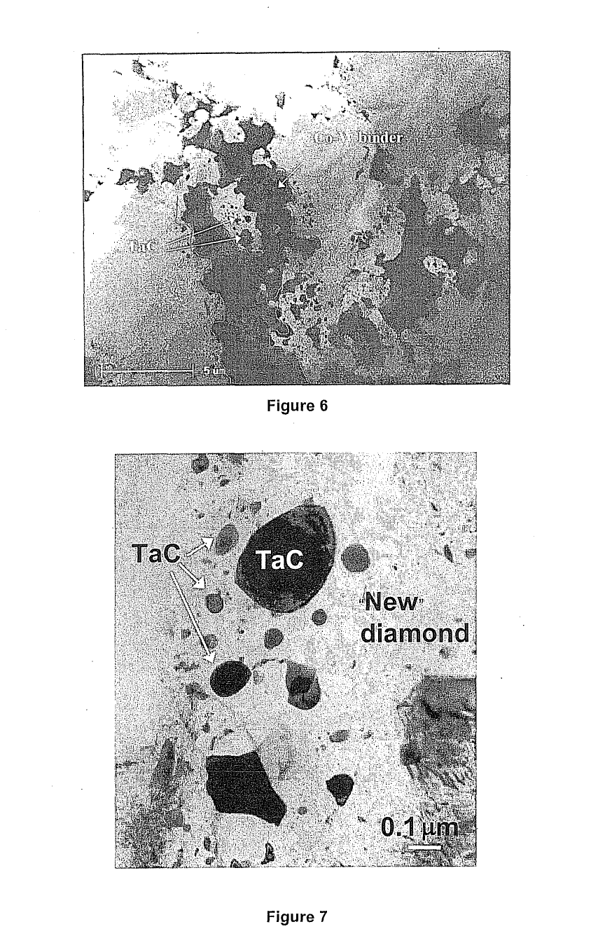

The microstructure of this compact was investigated using a Transmission Electron Microscope (TEM) to determine the type of carbide deposition and this is shown in accompanying FIGS. 6 and 7.

FIG. 6 shows a low magnification image of the compact of Example 2, whilst FIG. 7 shows a higher magnification image taken of the same compact. Although the type of deposition has not been optimized, it is clear from FIGS. 6 and 7 that the TaC is occluded in the regions of re-grown or newly grown diamond. FIG. 6 shows the occurrence of the occluded TaC occurring predominantly in the re-grown diamond very near to the cobalt-diamond interface (as outlined). TEM analysis showed the carbide deposit to be TaC, but XRD analysis indicated the presence of both Ta₂C and TaC. It is very likely that Ta₂C is also present in a similar type of deposition.

### Example 3

A mixture of 5 weight % TaB and the balance a bimodal mixture of diamond particles was ball milled for 1 hour in order to form a uniform mixture. Scanning electron microscopy (SEM) showed the resultant mixture to be homogeneous. The mixture was then backed with a cemented tungsten carbide substrate incorporating solvent/catalyst cobalt, and treated in a vacuum furnace to remove any impurities. The pre-composite was then subjected to high pressures and temperatures in order to obtain a sintered compact.

SEM analysis showed the presence of a substantial amount of diamond intergrowth in the compact. Electron diffraction spectroscopy and X-ray diffraction were used to confirm the presence of metal carbides and metal borides in the sintered compact. In terms of the analysis test results, the results obtained were similar to those obtained for Example 1 in that there was a definite improvement in the thermal stability of the PCD compact.

1. A polycrystalline diamond (PCD) material comprising a skeletal diamond structure formed of intergrown diamond grains and defining interstitial regions between the diamond grains, wherein the skeletal diamond structure contains metal carbide structures or particles that are occluded from the interstitial regions by diamond.

2. A PCD material according to claim 1, wherein the PCD material has an oxidation onset temperature of at least 800 degrees centigrade.

3. A PCD material according to claim 1, wherein the metal carbide structures or particles comprise a carbide compound of a refractory metal that has a solubility in cobalt of about 15 atomic percent or less at about 1,100 degrees centigrade.

4. A PCD material according to claim 1, wherein the metal carbide structures or particles comprise tantalum carbide, niobium carbide, titanium carbide, zirconium carbide, tungsten carbide or molybdenum carbide.

5. A PCD material according to claim 1, wherein the metal carbide structures or particles comprise tantalum carbide.

6. A PCD material according to claim 1, wherein at least some of the intergrown diamond grains comprise an inner volume and an outer volume, the outer volume being integrally formed over at least part of the inner volume, the inner volume comprising plastically deformed diamond, the diamond of the outer volume being substantially less plastically deformed than that of the inner volume, and the occluded metal carbide structures or particles occuring within the outer volumes of the intergrown diamond grains.

7. A PCD material according to claim 6, wherein the respective outer volumes comprise from about 1 percent or more and from about 50 percent or less of the total volume of the skeletal diamond structure.

8. A PCD material according to claim 1, wherein the mean size of the metal carbide structures or particles is from about 0.05 microns or more and from about 5 microns or less.

9. A PCD material according to claim 1, wherein the interstitial region or regions within at least a portion of the PCD material contain a filler material comprising a solvent/catalyst for diamond.

10. A PCD material according to claim 1, wherein the PCD material comprises at least 90 volume percent diamond, the inter-grown diamond grains having a mean size in the range from 0.1 micrometres to 25 micrometres.

11. A PCD composite structure comprising a first portion having a first skeletal diamond structure formed of intergrown diamond grains and defining interstitial regions between the diamond grains and a second portion having a second skeletal diamond structure formed of intergrown diamond grains and defining interstitial regions between the diamond grains, the first skeletal structure containing metal carbide structures or particles that are occluded from the interstitial regions of the first portion by diamond, and the second skeletal structure being substantially devoid of metal carbide structures or particles that are occluded from the interstitial regions of the second portion by diamond.

12. A PCD composite structure according to claim 11, wherein the first portion is adjacent a working surface and the second portion is remote from the working surface.

13. A PCD composite compact element comprising a PCD structure secured to a support substrate formed of cemented carbide, wherein the PCD structure is formed of PCD material according to claim 1.

14. A method of manufacturing a PCD compact, the method including introducing a metal carbide former, in the form of a metal compound comprising a metal that is capable of reacting with carbon to form a metal carbide, and boron and/or nitrogen, into an aggregated plurality of diamond grains to form a pre-sinter mass, and sintering the pre-sinter mass in the presence of a solvent/catalyst material for diamond at a pressure and a temperature at which diamond is thermodynamically stable in order to form PCD.

15. A method according to claim 14, wherein the pressure is at least 5.5 gigapascals and the temperature is at least 1,400 degrees centigrade.

16. A method according to claim 14, wherein the metal compound comprises a boride, nitride, carbo-nitride, boro-nitride, metal boro-carbide or metal boro-carbo-nitride of a refractory metal that has a solubility in cobalt of about 15 atomic percent or less at about 1,100 degrees centigrade.

17. A method according to claim 14, wherein the metal compound is a nitride, boride, carbo-nitride or boro-nitride of tantalum, niobium, titanium, zirconium, tungsten or molybdenum.

18. A method according to claim 14, wherein the metal compound is tantalum boride, TaB or TaB₂, tantalum nitride, tantalum carbo-nitride, tantalum boro-nitride, niobium boride or zirconium diboride.

19. A method according to claim 14, wherein the metal compound is tantalum diboride.

20. A tool comprising a PCD composite compact element according to claim 13, the tool being for cutting, milling, grinding, drilling, earth boring, rock drilling or other abrasive applications.
